(19) United States
(12) Patent Application Publication
(10) Pub. No.: US 2010/0222813 A1
(43) Pub. Date: Sep. 2, 2010

(54) Apparatus for pacifying an infant

(76) Inventor: Kristie Lynn Gates, Massillon, OH (US)

Correspondence Address: Kristie Gates, 3423 Stahl Ave N.W., Massillon, OH, 44646, US

(21) Appl. No.: 12/380,692

(22) Filed: Mar. 2, 2009

(51) Int. Cl. A61J 17/00

(52) U.S. Cl. 606/234

(57) ABSTRACT

An apparatus for pacifying an infant with a rotating joint which allows the pacifier to move, and the rotating joint allows the pacifier to move with the mouth.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of pacifier and more specifically to an apparatus for pacifying an infant.

A pacifier has been used typically to calm an infant, for instances such as the infant being tired, hungry, or possibly teething. The pacifier is put in the infant's mouth in hopes of comforting it.

The most widely known pacifier includes some sort of rubber or silicon nipple attached to a plastic shield. A plastic ring is attached in order to hold on to the pacifier. Another method for calming an infant is the caregiver using his or her finger. If a caregiver has not washed their finger, this could prove to be very unhealthy for the infant, even possibly becoming sick from this.

The prior technology is deficient in that the pacifier is not mobile and lacks range of motion, therefore falls out of the infant's mouth much easier.

### BRIEF SUMMARY OF THE INVENTION

The primary object of the invention is to provide a better pacifier for calming an infant.

Another object of the invention is to provide a pacifier that stays in the infant's mouth better.

Another object of the invention is to provide a pacifier which moves with the infants mouth.

A further object of the invention is to provide a pacifier that when held by the caregiver and or infant the pacifier will rotate with the infant's mouth.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an apparatus for pacifying an infant comprising: a rotating joint which allows the pacifier to move, and the rotating joint allows the pacifier to move with the mouth.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the pacifying device in accordance with the invention.

FIG. 2 is a perspective front view showing range of motion of the invention.

FIG. 3 is a perspective side view of the invention.

FIG. 4 is a schematic diagram illustrating the operation of the rotating joint of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The present device is a pacifier apparatus that when put in the infant's mouth will move with the infant while pacifying the infant. The pacifier apparatus compromises a pacifier that includes a nipple portion fixed to a rigid guard. A rotating joint attachment means is further included that is fixed to the pacifier rigid guard. As such, the pacifier, when fixed to the rotating joint, may be rotated 360 degrees.

The present invention is a widely adjustable pacifier apparatus that allows the infant to be able to rotate the pacifier 360 degrees with the infant's mouth. This will become apparant from the following more detailed description, taken in conjunction with the accompanying drawings, which illustrate, by way of example, the principles of the invention.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

### DETAILED DESCRIPTION OF THE DRAWINGS

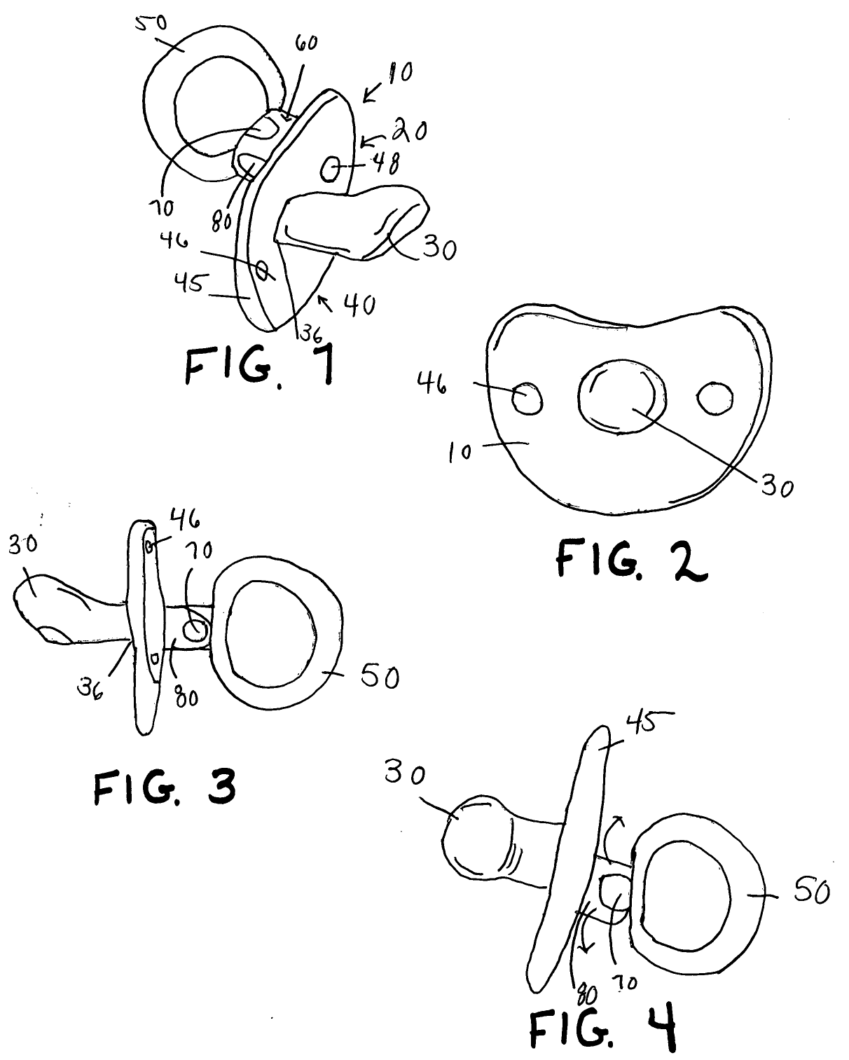

FIG. 1 Ilustrates a Pacifier System 10 that can move in a 360 degree rotation. The Pacifier System 10 compromises of a Pacifier Assembly 20 that includes a nipple portion 30 fixed at a distal end 36 thereof to a proximal side 44 of a rigid guard 40. Such a guard 40 includes a distal side 46 and at least one peripheral edge 45 connected the proximal and distal sides 44, 46. The rigid guard 40 may further include at least one aperture 48 for promoting air flow to a pacifier user's lips and mouth. The guard 40 is preferably made from a rigid platsic material that is dishwasher sage and non-toxic. Further, the guard 40 is large enough not to be swallowed by a typical child under two years of age. A finger attachment 50 is also made from a rigid platic material which is attached to a pivoting type attachment 80 which compromises a pivoting type ball 70 which allows the pacifier system to move in a 360 degree rotation. Preferably the pivot ball 70 and the pivot attachment/socket 80 are each compromised of a somewhat resilient plastic material which is also attached to the rigid guard 40.

What is claimed is:

1. An apparatus for pacifying an infant comprising:
a rotating joint which allows the pacifier to move; and
the rotating joint allows the pacifier to move with the mouth.
